(19) United States
(12) Patent Application Publication
(10) Pub. No.: US 2012/0060721 A1
(43) Pub. Date: Mar. 15, 2012

(54) SLURRY CHROMIZING COMPOSITIONS

(75) Inventors: Lawrence Bernard Kool, Clifton Park, NY (US); Brian Thomas Hazel, West Chester, OH (US); Michael Howard Rucker, Cincinnati, OH (US)

(73) Assignee: GENERAL ELECTRIC COMPANY, Schenectady, NY (US)

(21) Appl. No.: 11/833,460

(22) Filed: Aug. 3, 2007

Related U.S. Application Data
(63) Continuation-in-part of application No. 10/633,888, filed on Aug. 4, 2003, now Pat. No. 7,270,852.

(51) Int. Cl. C09D 5/08

(52) U.S. Cl. 106/14.21; 106/14.05; 106/14.44

(57) ABSTRACT

Slurry coating composition for selectively enriching surface regions of a metal-based substrate, for example, the under-platform regions of a turbine blade, with chromium. The slurry coating composition contains metallic chromium, optionally metallic aluminum in a lesser amount by weight than chromium, and optionally other constituents. The composition further includes colloidal silica, and may also include one or more additional constituents, though in any event the composition is substantially free of hexavalent chromium and sources thereof. The coating composition can be used in a process that entails applying the coating composition to a surface region to form a slurry coating, and then heating the coating to remove any volatile components of the coating composition and thereafter cause diffusion of chromium from the coating into the surface region to form a chromium-rich diffusion coating.

### CROSS REFERENCE TO RELATED APPLICATIONS

This is a continuation-in-part patent application of co-pending U.S. patent application Ser. No. 10/633,888, filed Aug. 4, 2003, the contents of which are incorporated herein by reference.

### BACKGROUND OF THE INVENTION

The present invention generally relates to protective coating systems suitable for components exposed to high temperatures, such as the hostile thermal environment of a gas turbine engine. More particularly, this invention relates to slurry coating compositions and processes for selectively enriching surface regions of a component, for example, the under-platform regions on a turbine blade, with corrosion-resistant metals such as chromium.

Components of turbine engines, such as the blades and vanes (nozzles) within the turbine section of a gas turbine engine, are often formed of an iron, nickel, or cobalt-base superalloy. A turbine blade has an airfoil against which hot combustion gases are directed during operation of the gas turbine engine, and whose surface is therefore subjected to severe attack by oxidation, corrosion and erosion. The blade further includes a platform and an under-platform or root section separated from the airfoil by the platform that, while not directly exposed to hot gas path, are still exposed to high temperatures and are susceptible to oxidation and corrosion. Turbine blades are typically anchored to the perimeter of a rotor or wheel by forming the rotor to have slots with dovetail cross-sections that interlock with a complementary dovetail profile on the root section of each blade.

Due to the severity of their operating environments, turbine blades often require environmentally protective coatings on the surfaces of their airfoils and platforms exposed to the hot gas path. Diffusion coatings such as chromide, aluminide, and platinum aluminide coatings are widely used as environmental coatings in gas turbine engine applications because of their oxidation resistance. Such coatings, which are typically applied to the internal and external surfaces of a blade, are produced by a thermal/chemical reaction process that results in the near-surface region of the substrate being enriched with, depending on the type of coating, chromium, aluminum, platinum, etc., as well as intermetallics that form as a result of reactions between the deposited corrosion-resistant specie(s) and the substrate material. Diffusion coating processes typically take place in a reduced and/or inert atmosphere at elevated temperatures. Common processes include pack cementation and noncontact vapor (gas phase) deposition techniques, or by diffusing corrosion-resistant species deposited by chemical vapor deposition (CVD) or slurry coating.

In pack cementation and noncontact vapor deposition techniques, vapor of the desired corrosion-resistant coating species (e.g., chromium, aluminum, etc.) is generated and caused to contact surfaces on which the coating is desired. The vapor reacts with the surface to deposit the desired coating specie(s), which are then diffused into the surface through a heat treatment. Aluminide diffusion coatings deposited by pack cementation or noncontact vapor deposition are often preferred for turbine blade airfoils. The dovetails of turbine blades are typically machined prior to the diffusion coating process, and may be masked during coating so that the dovetail will properly assemble with the dovetail slot in the rotor during engine build. However, during engine operation the under-platform regions of the blade can become corroded. In the past, corrosion of under-platform regions of turbine blades has been addressed by applying a vapor-phase chromide coating. While capable of improving corrosion resistance, vapor-phase chromizing processes require masking to prevent the chromide coating from being deposited on other surfaces of the blade, such as those already provided with an aluminide coating. However, masking is time-consuming, expensive, and not always effective.

Slurry processes generally entail the use of an aqueous or organic solvent slurry containing a volatile liquid vehicle and a powder of the corrosion-resistant coating specie(s) that can be sprayed or otherwise applied to a substrate, after which the substrate is heated to evaporate the volatile components of the slurry and, with further heating, diffuse the remaining coating species into the substrate. An example of a slurry composition is disclosed in U.S. Pat. No. 3,248,251 to Allen as containing aluminum particulates dispersed in an aqueous, acidic bonding solution that also contains metal chromate, dichromate or molybdate, and phosphate (the latter of which serves as a binder). The chromate ions are known to improve corrosion resistance. One prevalent theory described in U.S. Pat. No. 6,074,464 is that chromate ions passivate the bonding solution toward aluminum and inhibit the oxidation of metallic aluminum. In this manner, particulate aluminum can be combined with the bonding solution without undesirable reactions between the solution and aluminum. The coatings described in Allen are known to very effectively protect some types of metal substrates from oxidation and corrosion, particularly at high temperatures.

A drawback of slurry compositions of the type taught by Allen is the reliance on the presence of chromates, which are considered toxic. In particular, hexavalent chromium is considered to be a carcinogen. When compositions containing this form of chromium are used (e.g., in spray booths), special handling procedures closely followed to satisfy health and safety regulations can result in increased costs and decreased productivity. Therefore, attempts have been made to formulate slurry compositions which do not rely on the presence of chromates. For example, U.S. Pat. No. 6,150,033 describes chromate-free coating compositions used to protect metal substrates such as stainless steel. Many of the compositions disclosed in this patent are based on an aqueous phosphoric acid bonding solution, which comprises a source of magnesium, zinc, and borate ions. However, chromate-free slurry compositions can have various disadvantages, such as instability over the course of several hours (or even minutes), and generation of unsuitable levels of gases such as hydrogen. Furthermore, chromate-free slurry compositions have been known to thicken or partially solidify, rendering them very difficult to apply to a substrate by spray techniques. Moreover, the use of phosphoric acid in the compositions may also contribute to instability, especially if chromate compounds are not present since the latter apparently passivates the surfaces of the aluminum particles. In the absence of chromates, phosphoric acid may attack the metallic aluminum particles in the slurry composition, rendering the composition thermally and physically unstable. At best, such a slurry composition will be difficult to store and apply to a substrate.

In view of the above, there are ongoing efforts to develop new slurry compositions capable of forming environmentally-protective coatings on substrates. Such compositions should be capable of incorporating as much corrosion-resistant species as necessary into a substrate, and should also be substantially free of chromate compounds, especially hexavalent chromium. Moreover, improved slurry compositions should be chemically and physically stable for extended periods of use and storage, amenable to slurry application by various techniques such as spraying, painting, and the like, and should be generally compatible with other techniques which might be used to treat a particular metal substrate, for example, superalloy components such as turbine blades.

### BRIEF SUMMARY OF THE INVENTION

The present invention provides slurry coating compositions for selectively enriching surface regions of metal-based substrates, for example, the under-platform regions of a turbine blade, with chromium.

The slurry coating composition of this invention contains a metallic powder whose bulk composition contains metallic chromium, optionally metallic aluminum in a lesser amount by weight than chromium, and optionally other constituents. The composition further includes colloidal silica, and may also include one or more additional constituents, though in any event the composition is substantially free of hexavalent chromium and sources thereof.

The slurry coating composition of this invention can be employed in a process that generally entails preparing the slurry coating composition, applying the slurry coating composition to the surface region of the substrate to form a slurry coating on the surface region, and then heat treating the slurry coating to remove any volatile components of the slurry coating composition and thereafter cause diffusion of chromium from the slurry coating composition into the surface region of the substrate to form a chromium-rich diffusion coating.

Notable advantages associated with the slurry coating composition of this invention include its effectiveness in chromizing a metal substrate, the ease with which the composition can be economically prepared, and the ease with which the content of the coating species in the composition can be readily adjusted to meet the requirements for a particular substrate. Moreover, the slurry coating composition of this invention exhibits highly desirable stability characteristics while being free of chromate compounds, including hexavalent chromium, and free of phosphoric acid. Furthermore, the slurry coating composition can be applied by a number of different techniques, and its wetting ability promotes the formation of a relatively uniform coating.

Other objects and advantages of this invention will be better appreciated from the following detailed description.

### BRIEF DESCRIPTION OF THE DRAWINGS

FIG. 1 is a perspective view showing a representative example of a high pressure turbine blade.

FIGS. 2 and 3 are scanned images of cross-sections through substrates protected with a chromide diffusion coating deposited in accordance with the present invention.

### DETAILED DESCRIPTION OF THE INVENTION

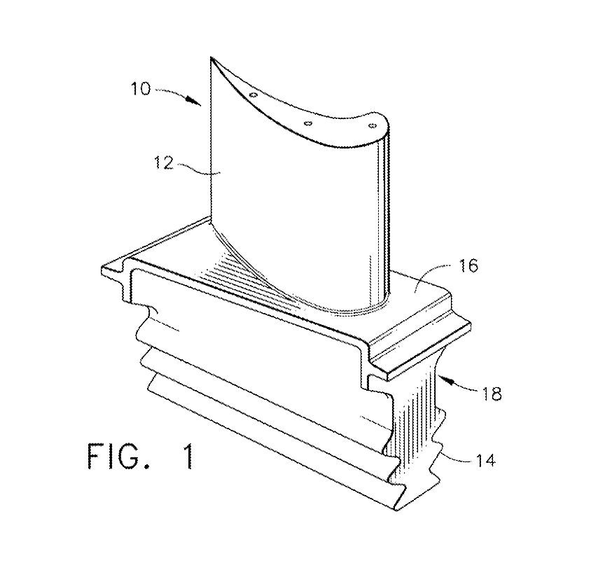

The slurry coating composition of the present invention is adapted to selectively enrich surface regions of substrates with chromium and preferably also aluminum. A particular application is the under-platform regions on turbine blades of gas turbine engines, an example of which is a high pressure turbine blade 10 shown in FIG. 1. The blade 10 generally includes an airfoil 12 against which hot combustion gases are directed during operation of the gas turbine engine, and whose surface is therefore subjected to severe attack by oxidation, corrosion and erosion. For this reason, the airfoil 12 is typically protected from the hostile environment of the turbine section by an environmentally-resistant coating, for example, a diffusion coating such as an aluminide or platinum aluminide coating often deposited by pack cementation or noncontact vapor deposition. The blade 10 is configured to be anchored to a turbine disk (not shown) with a dovetail 14 formed on a root section of the blade 10. A platform 16 separates the airfoil 12 and dovetail 14, such that the root section, its dovetail 14, and the underside of the platform 16 can be are referred to as under-platform regions 18 of the blade 10. Though not directly exposed to the hot gas path of a turbine engine, the under-platform regions 18 are nonetheless susceptible to oxidation and corrosion. Slurry coating compositions and processes of this invention are particularly adapted to selectively form a chromium-containing coating on the surfaces of the under-platform regions 18 of the blade 10 of FIG. 1, as well as surfaces of other components similarly subjected to oxidation and corrosion.

The slurry coating compositions of this invention contain a powder of metallic chromium (i.e., in a zero oxidation state), and preferably also metallic aluminum. The composition preferably contains colloidal silica as the liquid vehicle. The term “colloidal silica” is meant to embrace any dispersion of fine particles of silica in a medium of water or another solvent, with water being preferred such that the slurry composition is a water-based (aqueous) system. Dispersions of colloidal silica are available from various chemical manufacturers in either acidic or basic form. Moreover, various shapes of silica particles can be used, e.g., spherical, hollow, porous, rod, plate, flake, or fibrous, as well as amorphous silica powder. Spherical silica particles are generally preferred. The particles may have an average particle size in a range of about 10 nanometers to about 100 nanometers. Nonlimiting examples of references which describe colloidal silica include U.S. Pat. Nos. 4,027,073 and 5,318,850, which are incorporated herein by reference. Commercial examples of colloidal silica are available under the names Ludox® and Remasol® from REMET Corporation, of Utica, N.Y., USA.

The amount of colloidal silica present in the composition will depend on various factors, for example, the amount of metallic powder used and the presence (and amount) of any other constituents in the slurry, for example, an organic stabilizer as discussed below. Colloidal silica appears to function primarily as a very effective binder in the slurry composition. Processing conditions are also a consideration, for example, how the slurry is formed and applied to the under-platform regions 18. The colloidal silica may be present at a level in the range of about 1% to about 25% by weight, based on silica solids as a percentage of the entire composition. In especially preferred embodiments, the amount is in the range of about 10% to about 20% by weight.

The metallic powder may constitute, by weight, about 25% to about 80%, more preferably about 30% to about 50%, of the entire slurry composition. The powder particles may be in the form of spherical particles, though other forms are possible as well, such as wire, wire mesh, and those described above for the colloidal silica. The metallic powder can be used in a variety of standard sizes. Preferred sizes for the powder particles will depend on several factors, such as the alloy of the under-platform regions 18, the technique by which the slurry is to be applied to the under-platform regions 18, and the presence and amounts of other potential constituents in the slurry. An example of a suitable average particle size range is about 0.5 to about 200 micrometers. In some preferred embodiments, the powder particles have an average particle size in the range of about 1 to about 50 micrometers, with a particularly preferred range being about 1 to about 20 micrometers. The powder particles can be produced by various processes, including gas atomization processes, rotating electrode techniques, etc.

In the illustrated example, the metallic powder serves as the source for the corrosion-resistant species, chromium and optionally aluminum, desired for the under-platform regions 18 of the blade 10. As such, the metallic powder contains particles of at least chromium, and optionally particles of both chromium and aluminum or additional and separate particles of aluminum, such that the bulk composition of the metallic powder contains less aluminum by weight than chromium. The powder may also contain other elements capable of imparting desired characteristics to the under-platform regions 18, e.g., enhanced oxidation resistance, phase stability, environmental resistance, and sulfidation resistance. For example, the powder may contain one or more platinum group metals (platinum, palladium, ruthenium, rhodium, osmium, and iridium), and/or one or more rare earth metals (lanthanides) such as lanthanum, cerium, and erbium. Elements which are chemically-similar to the lanthanides could also be included, such as scandium and yttrium. In some instances, it may also be desirable to include one or more of iron, cobalt, and silicon. Moreover, those skilled in the art understand that the powder may also contain various other elements and other materials at impurity levels, e.g., less than about 1% by weight. Techniques for preparing powders formed from any combination of the optional elements described above are also well known in the art and available from a number of commercial sources, and therefore will not be discussed in any detail here.

Suitable and preferred compositions for the chromium-based powder and its amount in the slurry composition will depend in large part on the amount of chromium desired for the under-platform regions 18. In general, suitable amounts of chromium and optionally aluminum in the slurry composition should exceed their respective amounts in the substrate to be protected. The chromium content of the slurry composition is also preferably sufficient to compensate for any projected loss of chromium from the under-platform regions 18 under expected operating conditions, such as temperatures, temperature/time schedules and cycles, and environmental conditions. Preferred coatings produced by this invention on nickel-base superalloy substrates contain at least 15 to less than 60 weight percent chromium, and preferably about 25 to about 30 weight percent chromium, and further contain aluminum in an amount below that at which a continuous beta intermetallic (NiAI) phase will form (for example, less than 18 weight percent aluminum, though this value will depend on the coating composition, including the amount of chromium), with the balance of the coating being nickel and other constituents present in the substrate. More generally, suitable powder materials contain more chromium than aluminum by weight, and particularly suitable powder materials are predominantly metallic chromium (in other words, contain more chromium by weight than any other constituent), for example, at least about 51 weight percent chromium and about 5 to about 49 weight percent aluminum. A particular example is a chromium-aluminum alloy powder that contains about 44 weight percent aluminum with the balance chromium and incidental impurities. To produce a preferred coating on a nickel-base superalloy as noted above, preferred powder materials contain at least about 15 weight percent (such as about 15 to about 60 weight percent) chromium, about 2 to about 18 weight percent aluminum, and optionally up to about 83 weight percent of one or more platinum group metals, lanthanide metals, scandium and/or yttrium. Based on the ranges for the metallic powder in the slurry and ranges for chromium and aluminum in the metallic powder, suitable amounts of chromium and aluminum in the slurry are, by weight, about 10% to about 70% and about 2% to about 20%, respectively, and preferred amounts of chromium and aluminum in the slurry are, by weight, of about 25% to about 30% and about 5% to about 18%, respectively. However, it should be noted that, depending on the particular operating conditions for the under-platform regions 18 and their various surface regions, these levels may be adjusted to allow for the presence of other metals intended for diffusion, as described above.

In addition to the metallic powder and colloidal silica, the slurry composition may further include other constituents, most notably one or more organic stabilizers. Suitable stabilizers are organic compounds that contain at least two hydroxyl groups (dihydric alcohols), and in some preferred embodiments contain at least three hydroxyl groups (trihydric (polyhydric) alcohols, or polyols). Stabilizers that are water-miscible are also believed to be preferred, although this may not be a requirement. Nonlimiting examples of the stabilizer include alkane diols (sometimes referred to as “dihydroxy alcohols”) such as ethanediol, propanediol, butanediol, and cyclopentanediol. Suitable dihydroxy alcohols include those referred to as glycols, for example, ethylene glycol, propylene glycol, and diethylene glycol. The diols can be substituted with various organic groups, for example, alkyl or aromatic groups. Nonlimiting examples of the substituted versions include 2-methyl-1,2-propanediol, 2,3-dimethyl-2,3-butanediol, 1-phenyl-1,2-ethanediol, and 1-phenyl-1,2-propanediol.

Various other polymeric materials containing at least two hydroxy groups can also be employed as the organic stabilizer. Non-limiting examples include various fats (glycerides), such as phosphatidic acid (a phosphoglyceride). Another broad class of materials that may be employed includes carbohydrates, for example, as described in “Organic Chemistry” by Morrison and Boyd, 3rd Edition (1975), at pages 1070-1132. The term “carbohydrate” is meant to include polyhydroxy aldehydes, polyhydroxy ketones, or compounds that can be hydrolyzed to them. The term further includes materials such as lactose, along with sugars such as glucose, sucrose, and fructose. Many related compounds could also be used, for example, polysaccharides such as cellulose and starch, or components within the polysaccharides such as amylose. Water-soluble derivatives of any of these compounds are also known in the art and could be used.

Another particular example of a suitable organic stabilizer is glycerol, C₃H₅(OH)₃, sometimes referred to as “glycerin” or “glycerine.” Glycerol can readily be obtained from fats, i.e., glycerides. Another suitable organic stabilizer that contains more than three hydroxy groups (some of which are referred to as “sugar alcohols”) is pentaerythritol (C(CH₂OH)₄). Sorbitol and similar polyhydroxy alcohols represent other examples of suitable organic stabilizers. Still other suitable organic stabilizers are described in many standard texts, examples of which include of the “Organic Chemistry” text mentioned above and “The Condensed Chemical Dictionary,” Tenth Edition, Van Nostrand Reinhold Company (1981).

Based on factors such as cost, availability, and effectiveness, glycerols and dihydroxy alcohols such as the glycols are believed to be preferred as the organic stabilizer. Although not wishing to be bound by any specific theory, it appears that the tri-hydroxy functionality of compounds such as glycerol is especially effective at passivating aluminum within the slurry.

Suitable amounts for the organic stabilizer in the slurry composition are believed to be in a range of about 0.1% by weight to about 20% by weight, based on the total weight of the slurry composition. Preferred amounts are believed to be in a range of about 0.5% by weight to about 15% by weight, and will depend on various factors including the specific type of stabilizer present, its hydroxyl content, its water-miscibility, the effect of the stabilizer on the viscosity of the slurry composition, the amount of metallic powder in the slurry composition, the particle sizes of the metallic powder, the surface-to-volume ratio of the powder particles, the specific technique used to prepare the slurry, and the presence of any other components in the slurry composition. For example, if used in sufficient quantities, the organic stabilizer might be capable of preventing or minimizing any undesirable reaction between the metallic powder and any phosphoric acid present in the slurry. In preferred embodiments, the organic stabilizer is present in an amount sufficient to chemically stabilize the metallic powder during contact with water or any other aqueous components of the slurry, meaning that slurry remains substantially free of undesirable chemical reactions, including those that would increase the viscosity and/or temperature of the composition to unacceptable levels. For example, unacceptable increases in temperature or viscosity are those which could prevent the slurry composition from being easily applied to the under-platform regions 18, e.g., by spraying. As a very general guideline, compositions deemed to be unstable are those that exhibit (e.g., after a short induction period) a temperature increase of greater than about 10° C. within about one minute, or greater than about 30° C. within about ten minutes. In the alternative (or in conjunction with a temperature increase), these compositions may also exhibit unacceptable increases in viscosity over a similar time period.

The slurry composition described above can contain various other ingredients as well, including compounds known to those involved in slurry preparations. Nonlimiting examples include thickening agents, dispersants, deflocculants, anti-settling agents, anti-foaming agents, binders, plasticizers, emollients, surfactants, and lubricants. In general, such additives may used at a level in the range of about 0.01% by weight to about 10% by weight, based on the weight of the entire slurry composition.

As mentioned above, the slurry composition is preferably aqueous. In other words, it includes a liquid carrier (e.g., the medium in which the colloidal silica is employed) that is primarily or entirely water. As used herein, “aqueous” refers to slurry compositions in which at least about 65% and preferably at least about 80% of the volatile components are water. Thus, a limited amount of other liquids may be used in admixture with the water. Nonlimiting examples of the other liquids or “carriers” include alcohols, for example, lower alcohols with 1-4 carbon atoms in the main chain, such as ethanol. Halogenated hydrocarbon solvents are another example. Selection of a particular carrier composition will depend on various factors, such as the evaporation rate required during treatment of the under-platform regions 18 with the slurry, the effect of the carrier on the adhesion of the slurry to the under-platform regions 18, the solubility of additives and other components in the carrier, the “dispersability” of powders in the carrier, the carrier's ability to wet the under-platform regions 18 and modify the rheology of the slurry composition, as well as handling requirements, cost requirements, and environmental/safety concerns. Those of ordinary skill in the art can select the most appropriate carrier composition for a given application by considering these factors.

A suitable amount of liquid carrier employed is usually the minimum amount sufficient to keep the solid components of the slurry in suspension.

Amounts greater than that level may be used to adjust the viscosity of the slurry composition, depending on the technique used to apply the composition. In general, the liquid carrier will typically constitute about 10% by weight to about 30% by weight, preferably 20% by weight, of the entire slurry composition. It should be noted that the slurry is termed a solid-in-liquid emulsion.

Slurries are generally described in “Kirk-Othmer's Encyclopedia of Chemical Technology,” 3rd Edition, Vol. 15, p. 257 (1981), and in the 4th Edition, Vol. 5, pp. 615-617 (1993), as well as in U.S. Pat. Nos. 5,759,932 and 5,043,378, all of which are incorporated herein by reference. A good quality slurry is usually well-dispersed, free of air bubbles and foaming, and has a high specific gravity and good rheological properties adjusted in accordance with the requirements for the particular technique used to apply the slurry. Moreover, the solid particle settling rate in the slurry should be as low as possible, or should be capable of being controlled, e.g., by stirring. As previously noted, the slurry should also be chemically stable.

For embodiments in which the slurry composition is based on colloidal silica and a metallic powder of a chromium-aluminum alloy, there are no critical steps believed necessary to prepare the composition. Conventional blending equipment can be used, and the shearing viscosity can be adjusted by addition of the liquid carrier. Mixing of the ingredients can be undertaken at room temperature, or at temperatures up to about 60° C., e.g., using a hot water bath or other technique. Mixing is carried out until the resulting blend is uniform. Portions of the primary ingredients may be withheld temporarily during the blending operation to ensure intimate mixing. The additives mentioned above, if used, are usually added after the primary ingredients have been mixed, although this may depend in part on the nature of the additive.

For embodiments which utilize an organic stabilizer in conjunction with the chromium-based metallic powder and colloidal silica, certain blending sequences are highly preferred in some instances. For example, the organic stabilizer is usually first mixed with the metallic powder prior to any significant contact between the metallic powder and the aqueous carrier. A limited portion of the colloidal silica, e.g., one-half or less of the formulated amount, may also be included at this time (preferably added slowly) to enhance the shear characteristics of the mixture. The initial contact between the stabilizer and the metallic powder, in the absence of a substantial amount of any aqueous component, greatly increases the stability of the slurry composition.

The remaining portion of the colloidal silica is then added and thoroughly mixed into the blend. The other optional additives can also be added at this time. In some instances, it may be desirable to wait for a period of time, e.g., up to about twenty-four hours or more, prior to adding the remaining colloidal silica. This waiting period may enhance the “wetting” of the metallic powder with the stabilizer, but does not always appear to be necessary. Those skilled in the art can determine the effect of the waiting period on slurry stability without undue experimentation. Blending temperatures are as described above.

The sequence discussed above is very preferable for compositions which utilize the stabilizer. However, other techniques for mixing the ingredients may also be possible. For example, if all of the primary ingredients are mixed together rapidly, then adverse reactions between the metallic powder and colloidal silica could be prevented or minimized. However, the process should be monitored very closely for the occurrence of sudden increases in temperature and/or viscosity. Appropriate safeguards should be in place.

The use of this slurry composition is especially advantageous for enhancing the chromium content (and optionally the aluminum content) of the under-platform regions 18 turbine blades 10 formed of superalloy materials, though its application to other metal substrates is also within the scope of the invention. The term “superalloy” is usually intended to embrace complex cobalt, nickel, and iron-based alloys that include one or more other elements, such as chromium, rhenium, aluminum, tungsten, molybdenum, titanium, etc. Superalloys are described in many references, including U.S. Pat. No. 5,399,313, which is incorporated herein by reference. High temperature alloys are also generally described in “Kirk-Othmer's Encyclopedia of Chemical Technology,” 3rd Edition, Vol. 12, pp. 417-479 (1980), and Vol. 15, pp. 787-800 (1981). The actual configuration of blades treated with the slurry composition of this invention may vary widely, and therefore can differ from that shown in FIG. 1.

The slurry coatings can be applied to the under-platform regions 18 by a variety of techniques known in the art. Some examples of the deposition techniques are described in “Kirk-Othmer's Encyclopedia of Chemical Technology,” 4th Edition, Vol. 5, pp. 606-619 (1993). For example, the slurries can be slip-cast, brush-painted, dipped, sprayed, poured, rolled, or spun-coated onto the surfaces of the under-platform regions 18. Spray-coating is often the easiest way to apply the slurry coating to under-platform regions 18 of the turbine blade 10. The viscosity of the coating can be readily adjusted for spraying by varying the amount of liquid carrier used. Spraying equipment is well known in the art. Any spray gun for painting should be suitable, including manual or automated spray gun models, air-spray and gravity-fed models, and the like. Non-limiting examples are described in U.S. Pat. No. 6,086,997, incorporated herein by reference. Examples of commercially-available spray equipment carry the names Binks®, Grayco®, DeVilbiss®, and Paasche®. Adjustment in various spray gun settings (e.g., for pressure and slurry volume) can readily be made to satisfy the needs of a specific slurry-spraying operation.

The slurry can be applied as one layer or multiple layers. Multiple layers may sometimes be required to deliver the desired amount of chromium metal to the under-platform regions 18. If a series of layers is used, a heat treatment can be performed after each layer is deposited to accelerate removal of the volatile components. After the full thickness of the slurry has been applied, an additional optional heat treatment may be carried out to further remove volatile materials, such as the organic solvents and water. The heat treatment conditions will depend in part on the type of the volatile components in the slurry. An exemplary heating regimen is about five minutes to about two hours at a temperature in the range of about 80° C. to about 200° C. Longer heating times can compensate for lower heating temperatures, and vice versa.

The dried slurry is then heated to a temperature sufficient to diffuse the chromium (and, if present, aluminum and/or other metallic species) into the near-surface regions of the under-platform regions 18. As used herein, a “near-surface region” extends to a depth of up to about 200 micrometers into the surface of the under-platform regions 18, typically a depth of about 75 micrometers and preferably at least 25 micrometers into the surface, and includes both a chromium-enriched region closest to the surface and an area of interdiffusion immediately below the enriched region. Temperatures required for this chromizing step (i.e., the diffusion temperature) will depend on various factors, including the composition of the under-platform regions 18, the specific composition and thickness of the slurry, and the desired depth of enhanced chromium concentration. Usually the diffusion temperature is within the range of about 650° C. to about 1100° C., and preferably about 800° C. to about 950° C. These temperatures are also high enough to completely remove (by vaporization or pyrolysis) any organic compounds present, including stabilizers such as glycerol. The diffusion heat treatment can be carried out by any convenient technique, including heating in a vacuum or inert gas within an oven.

The time required for the diffusion heat treatment will depend on many of the factors described above. Generally, the time will range from about thirty minutes to about eight hours. In some instances, a graduated heat treatment is desirable. As a very general example, the temperature could be raised to about 650° C., held there for a period of time, and then increased in steps to about 850° C. Alternatively, the temperature could initially be raised to a threshold temperature such as 650° C. and then raised continuously, e.g., about 1° C. per minute, to reach a temperature of about 850° C. in about 200 minutes. Those skilled in the general art (e.g., those who work in the area of pack-aluminizing) will be able to select the most appropriate time-temperature regimen for a given substrate and slurry.

The following example is merely illustrative, and should not be construed to be any sort of limitation on the scope of the claimed invention.

A slurry was prepared containing metallic chromium and metallic aluminum, but free of any chromium not in the zero oxidation state (e.g., free of hexavalent chromium or precursors thereof). The slurry contained, by weight, about 80% metallic powder, about 17% colloidal silica, and about 3% organic stabilizer. The metallic powder was −250 mesh particles of a Cr-44AI alloy (by weight). The colloidal silica was Remasol® LP-30, having a concentration of about 30% SiO₂ in water, with a particle size of about 12 to about 13 nanometers. The stabilizer was glycerol. The glycerol was combined with about one-half of the formulated amount of LP-30 (i.e., about 8 weight percent), then the metallic powder was added and mixed for about five to about ten minutes to form a uniform paste. The remaining LP-30 was then added, resulting in the paste being diluted to form a slurry that underwent additional mixing for about fifteen minutes. The resulting slurry was very stable and did not exhibit any significant increase in temperature or viscosity after combining the ingredients.

Before settling could occur, the slurry was brushed onto the surface of a single-crystal coupon formed of a gamma prime-strengthened nickel-base superalloy commercially known under the name Rene N5 (U.S. Pat. No. 6,074,602) and having a nominal composition of, by weight, about 7.5% Co, 7.0% Cr, 6.5% Ta, 6.2% Al, 5.0% W, 3.0%Re, 1.5% Mo, 0.15% Hf, 0.05% C, 0.004% B, 0.01% Y, the balance nickel and incidental impurities. Prior to coating, the coupon was grit-blasted and washed with alcohol. A single coating was applied to the coupon to obtain a thickness (wet) of about 175 micrometers. The slurry coating was allowed to air-dry on the coupon, followed by curing in an oven at a temperature of about 400° F. (about 200° C.) for about one hour. The coated coupon was then diffusion heat-treated in a vacuum oven at a temperature of about 1950° F. (about 1065° C.) for about six hours. There was no evidence of coating spallation.

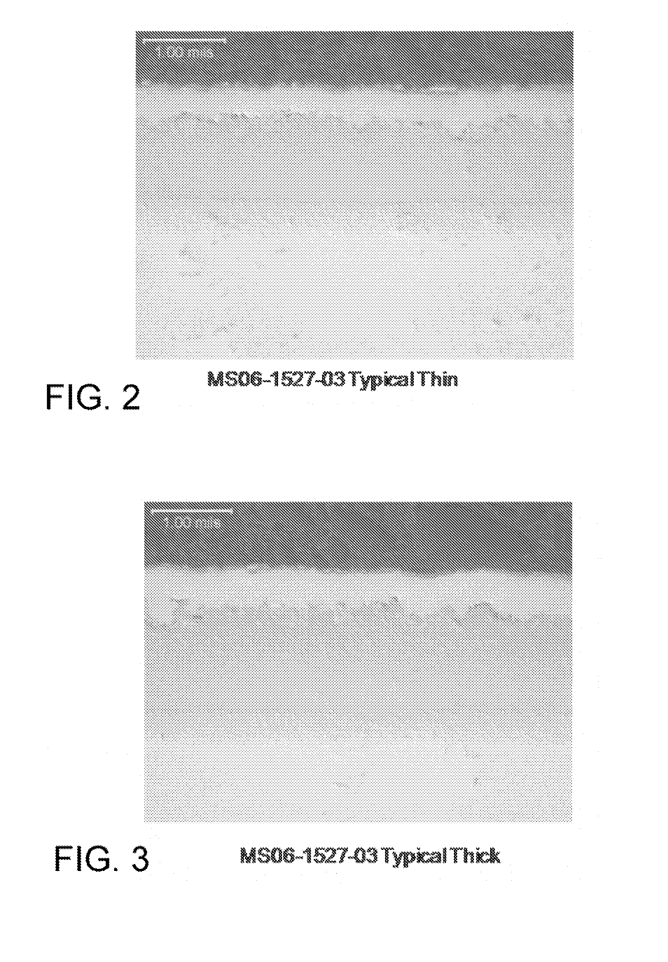

After cooling, the coated coupon was cross-sectioned for analysis. FIGS. 2 and 3 show cross-sections of two regions of the coupon and its coating, seen as a chromium and aluminum-enriched region on and in the surface of the coupon. The coating thickness (including the coating-coupon interdiffusion region) was in a range of about 2.8 to 3.4 mils (about 71 to about 86 micrometers), with an average thickness of about 3.1 mils (about 79 micrometers). FIGS. 2 and 3 are typical of thinner and thicker regions, respectively, of the coating.

A sample of the slurry was stored and its stability was monitored. It remained stable after at least six months, which was the limit of monitoring at that time.

In view of the above, the slurry composition of this invention was very effective in chromizing a metal substrate, and also exhibited highly desirable stability characteristics while being free of chromate compounds, including hexavalent chromium. The tested sample was also free of phosphoric acid and its derivatives. Further advantages of the slurry composition was the ease with which the slurry was prepared, the ease with which it can be applied by a number of different techniques, and its ability to form a relatively uniform coating.

While the invention has been described in terms of particular embodiments, it is apparent that other forms could be adopted by one skilled in the art. Therefore, the scope of the invention is to be limited only by the following claims.

1. A slurry coating composition for enriching a surface region of a metal-based substrate with chromium, the slurry coating composition comprising a metallic powder, colloidal silica, and optionally one or more additional constituents though substantially free of hexavalent chromium and sources thereof, the metallic powder having a bulk composition comprising metallic chromium and optionally metallic aluminum in a lesser amount by weight than the metallic chromium.

2. The slurry coating composition according to claim 1, wherein the metallic chromium constitutes at least 15 weight percent of the bulk composition of the metallic powder.

3. The slurry coating composition according to claim 1, wherein the bulk composition of the metallic powder is predominantly the metallic chromium.

4. The slurry coating composition according to claim 1, wherein the metallic powder consists of metallic chromium and incidental impurities.

5. The slurry coating composition according to claim 1, wherein the metallic powder further comprises the metallic aluminum.

6. The slurry coating composition according to claim 5, wherein the metallic aluminum constitutes about 2 to about 18 weight percent of the bulk composition of the metallic powder.

7. The slurry coating composition according to claim 5, wherein the metallic aluminum constitutes about 5 to about 49 weight percent of the bulk composition of the metallic powder, the balance being the metallic chromium and incidental impurities.

8. The slurry coating composition according to claim 1, wherein the colloidal silica comprises a liquid carrier selected from the group consisting of water, alcohols, halogenated hydrocarbon solvents, and compatible mixtures thereof.

9. The slurry coating composition according to claim 8, wherein the liquid carrier is water.

10. The slurry coating composition according to claim 1, wherein the slurry coating composition contains the one or more additional constituents selected from the group consisting of thickening agents, dispersants, deflocculants, anti-settling agents, anti-foaming agents, binders, plasticizers, emollients, surfactants, and lubricants.

11. The slurry coating composition according to claim 1, wherein the metallic powder is present in the slurry coating composition at a level in the range of about 25% by weight to about 80% by weight of the slurry coating composition.

12. The slurry coating composition according to claim 1, wherein the colloidal silica is present in the slurry coating composition at a level in the range of about 1% by weight to about 25% by weight, based on silica solids as a percentage of the slurry coating composition.

13. The slurry coating composition according to claim 1, wherein the metallic powder further comprises at least one metal selected from the group consisting of platinum group metals, rare earth metals, scandium, yttrium, iron, and cobalt.

14. The slurry coating composition according to claim 1, wherein the silica in the colloidal silica has an average particle size in the range of about 10 nanometers to about 100 nanometers.

15. The slurry coating composition according to claim 1, further comprising at least one organic compound that contains at least two hydroxyl groups.

16. The slurry coating composition according to claim 15, wherein the organic compound contains at least three hydroxyl groups.

17. The slurry coating composition according to claim 15, wherein the organic compound is selected from the group consisting of alkane diols, glycerol, pentaerythritol, fats, and carbohydrates.

18. The slurry coating composition according to claim 15, wherein the organic compound is present in an amount sufficient to chemically stabilize the metallic powder during contact with any aqueous component present in the slurry coating composition.

19. The slurry coating composition according to claim 18, wherein the organic compound is present at a level in the range of about 0.1% by weight to about 20% by weight, based on the total weight of the slurry coating composition.

20. The slurry coating composition according to claim 1, wherein the metallic powder has a particle size of −250 mesh.

21. The slurry coating composition according to claim 1, wherein the slurry coating composition is in the form of a coating on the surface region of the substrate, and the substrate is formed of a nickel-based superalloy.

22. The slurry coating composition according to claim 21, wherein the substrate is an under-platform region of a turbine blade of a gas turbine engine.
